(19) United States
(12) Patent Application Publication
(10) Pub. No.: US 2011/0107929 A1
(43) Pub. Date: May 12, 2011

(54) DEVICE IN A PRINTING UNIT OF A PRINTING MACHINE

(76) Inventors: Erich Max Karl Gerner, Butthard (DE); Bernhard Wilhelm Ernst, Veitshochheim (DE)

(21) Appl. No.: 12/736,775

(22) PCT Filed: Jan. 26, 2009
(86) PCT No.: PCT/DE2009/050004

§ 371 Date: Nov. 8, 2010

(30) Foreign Application Priority Data
May 19, 2008 (DE) 102008001848.1

(51) Int. Cl. B41F 5/00

(52) U.S. Cl. 101/216

(57) ABSTRACT

A device for use in a printing unit of a printing machine, with that printing unit comprising at least one roller of an inking unit or of a dampening unit of the printing unit and with at least one traverse drive for generating an axial traversing stroke of the roller, and also with at least one drive for the moving of the roller in a rotary manner. A magnetic coupling, which is comprised of an inner rotor and an outer rotor, is arranged between the roller and the drive. In order to compensate for the traversing stroke of the roller, the inner rotor and the outer rotor are movable relative to each other in the direction of the axis of rotation of the roller.

The invention relates to a device in a printing couple of a printing press according to the preamble to claim 1.

WO 2007/135155 A2 describes assemblies in a printing couple of a rotary printing press, each assembly comprising at least one forme cylinder, three ink forme rollers, two distribution rollers, and one ink flow dividing roller, wherein both of the distribution rollers are engaged directly against the ink flow dividing roller, wherein one of the ink forme rollers is engaged against one of the distribution rollers and against the forme cylinder, wherein the other two ink forme rollers are engaged against the distribution roller and against the forme cylinder, and wherein the forme cylinder is covered with a plurality of printing formes. The dampening unit of the printing couple comprises a smoothing roller which executes an oscillating stroke in the axial direction of the roller. The oscillating stroke can be generated by a stand-alone drive, or the oscillating stroke can be coupled to the drive for rotating the smoothing roller, in which case the oscillating stroke is derived from the rotational motion by means of a transmission.

WO 2005/007410 A2 describes a roller of an inking or dampening unit, which has both a separate motorized drive, embodied as a drive motor, and an oscillating drive. The roller is mounted on a spherical bushing, which is connected to the motor shaft of the drive motor via an angle or bevel gear transmission, an angle compensating coupling, and a shaft, and which transmits torque, wherein said mounting permits the transmission of rotational movement, while still allowing the roller to oscillate axially relative to the shaft. The balls of the spherical bushing run in longitudinal grooves in both the shaft and the bearing body. This allows torque to be transmitted, while allowing the bearing body to move axially relative to the shaft.

DE 101 61 889 A1 describes an inking unit of a printing press with an ink distribution roller, wherein the ink distribution roller is connected to a drive motor via a magnetic coupling comprising permanent magnets. The two coupling halves of the magnetic coupling are not able to move relative to one another in the direction of the rotational axis.

DE 39 17 074 A1 and DE 1 233 416 B disclose electromagnetic clutches in inking units. A compensation for an oscillating stroke within the clutch is not suggested.

The problem addressed by the invention is that of providing a device in a printing couple of a printing press, in which an oscillating stroke of a roller is compensated for, without wear and tear, and with low maintenance.

The problem is solved according to the invention by the features of claim 1.

The benefits to be achieved by the invention consist especially in that the oscillating stroke of the roller is compensated for in a contactless fashion due to the presence of a magnetic bearing or a magnetic coupling. The device is therefore free from wear and tear and requires low maintenance.

A further benefit is provided by the ease of assembly or production of the device, as comparatively complex and thus sensitive components can be dispensed with. In the simplest case, a magnetic bearing or magnetic coupling consists of two components, namely the outer rotor and the inner rotor, which enables a relatively simple production and assembly of the device.

An embodiment of the invention is depicted in the set of drawings and will be specified in greater detail in what follows.

The drawings show:

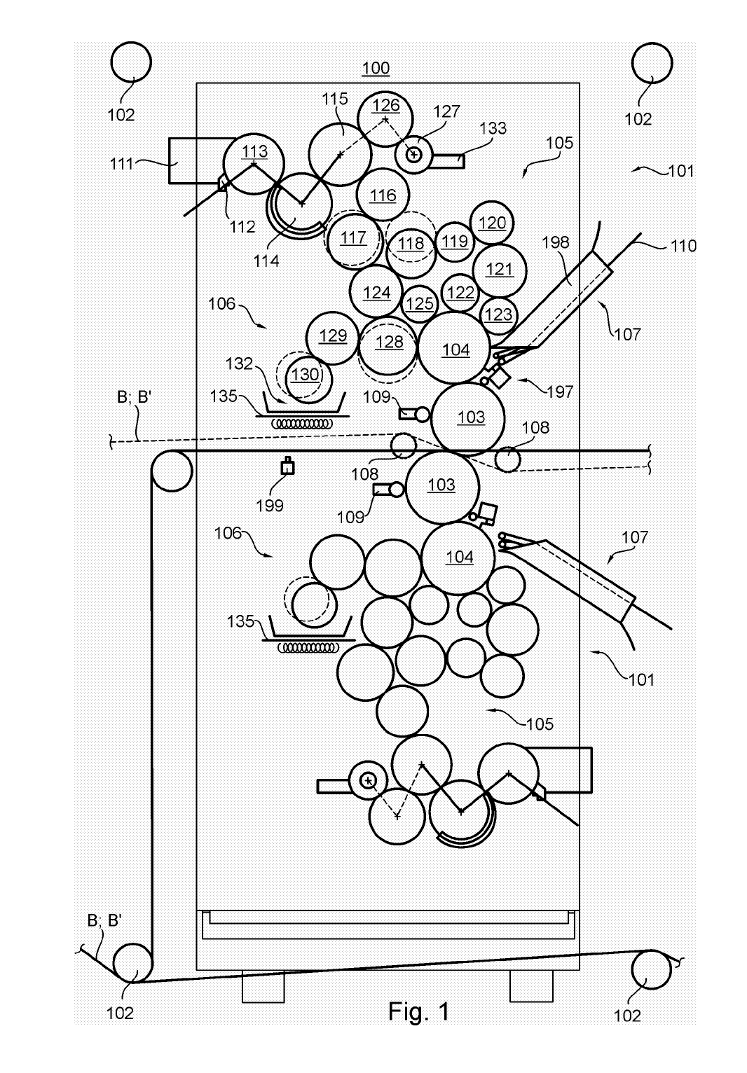

FIG. 1 a schematic illustration of a printing unit from a side view;

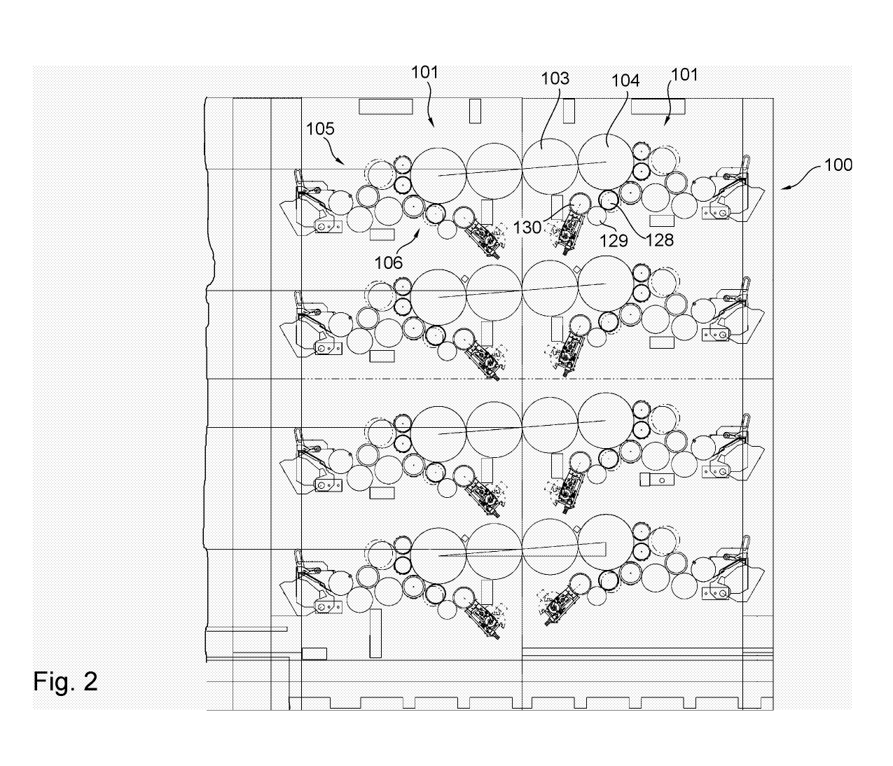

FIG. 2 a printing tower of a printing press with a plurality of printing units;

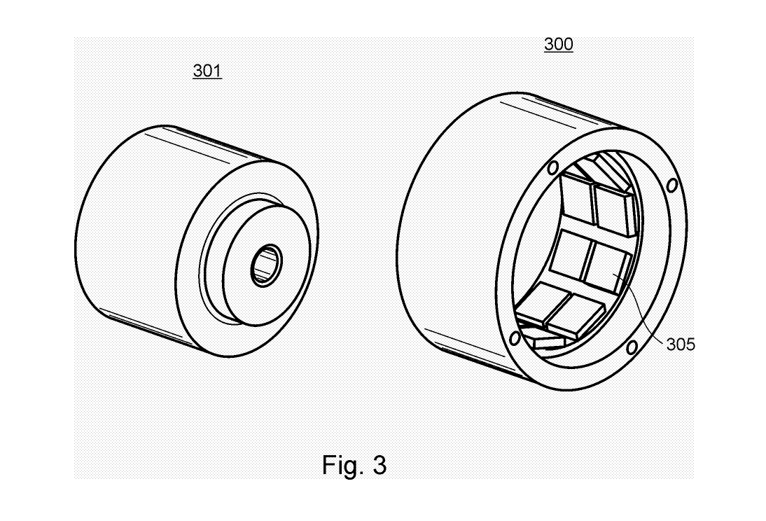

FIG. 3 a perspective, exploded view of a magnetic coupling with an inner rotor and an outer rotor;

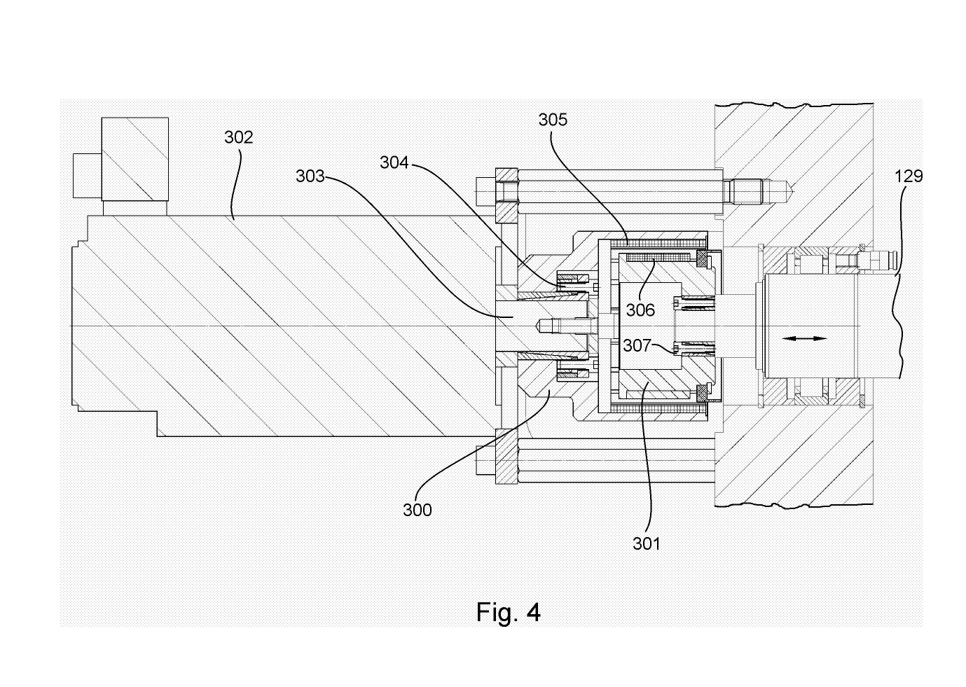

FIG. 4 a sectional diagram of a device in a printing couple of a printing press, with a roller of the printing couple and with a magnetic coupling for transmitting torque and for receiving the oscillating stroke;

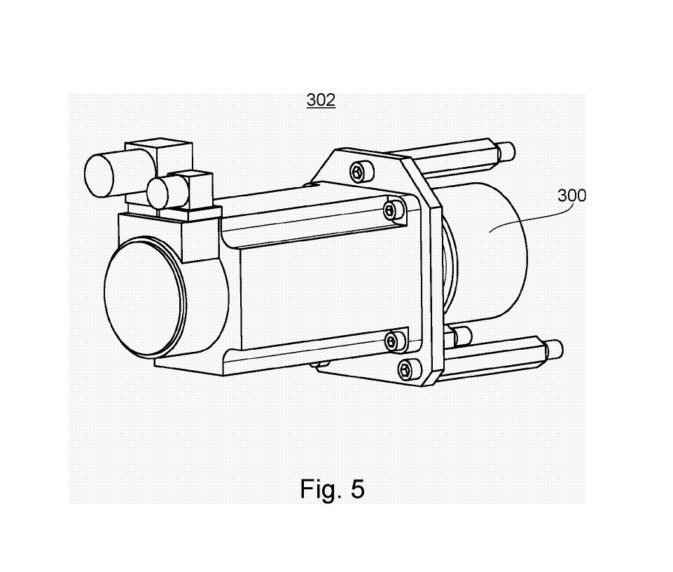

FIG. 5 a perspective view of the separate drive for driving the rotation of a roller of the printing couple, including the outer rotor of the magnetic coupling;

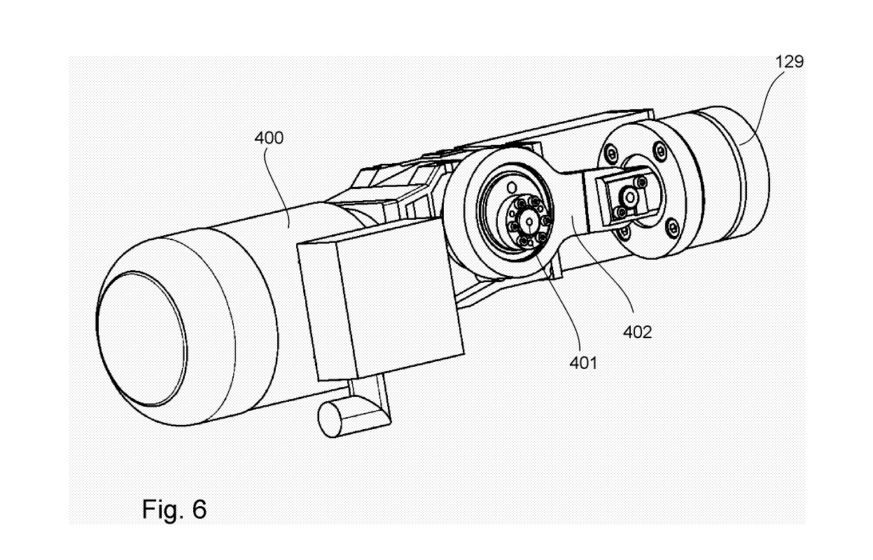

FIG. 6 a perspective view of the oscillating drive for effecting the oscillating stroke of a roller of the printing couple;

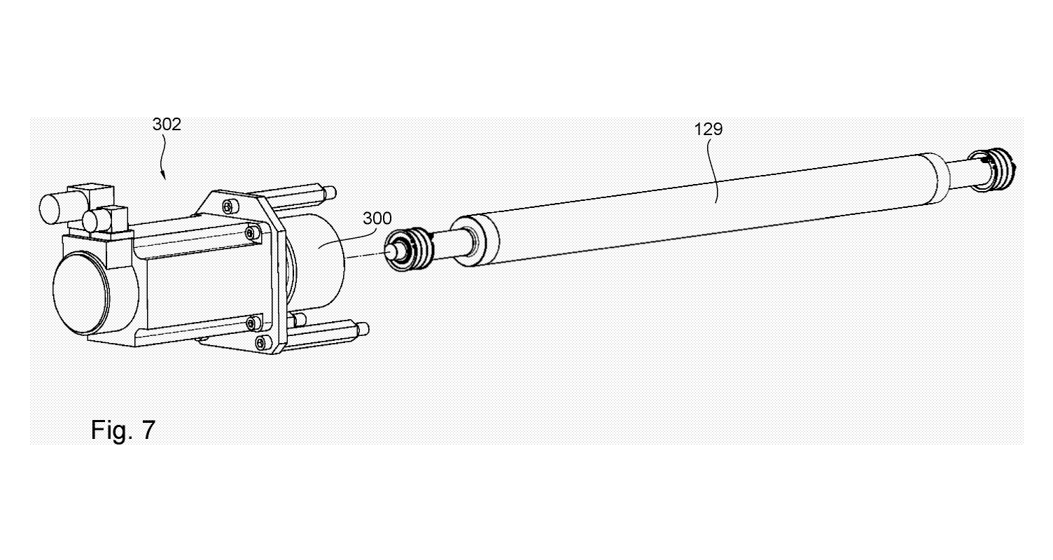

FIG. 7 a perspective, exploded view of the separate drive of FIG. 6, with a roller of the printing couple.

FIG. 1 shows a schematic illustration of a printing unit 100 of a printing press. Printing presses of this type have at least one, but preferably at least four or even five printing units 100 according to FIG. 1. The print substrate B; B′, preferably a material web B; B′, particularly a paper web B; B′ (in short, web B; B′), is reeled off of a reel unwinding unit and is then fed via an infeed unit to the printing units 100. The printing units 100 are preferably arranged side by side, and the web B; B′, also shown in FIG. 1, passes through said units horizontally. In addition to the multiple printing units 100 which are customarily provided for multicolor printing, additional printing units can be provided, which can then be used alternatingly with one or more of the other printing units 100, to enable a flying printing forme change, for example.

The printing unit 100 is preferably embodied as a printing unit 100 for offset printing, particularly as a blanket-to-blanket printing unit 100 or as an I-type printing unit 100 with two printing couples 101, for example, two offset printing couples 101 for double-sided printing in so-called blanket-to-blanket operation.

At least one of the printing units 100 is situated upstream, and at least one downstream, of rollers 102, at least in the lower area, and optionally in the upper area, by means of which rollers an incoming web B; B′ can be guided around the printing unit 100 at the top or the bottom, a web B; B′ that has been guided around an upstream printing unit 100 can be guided through the printing unit 100, or a web B; B′ that has been guided through the printing unit 100 can be guided around the downstream printing unit 100.

In the embodiment shown in FIG. 1, the printing unit 100 is embodied with two printing couples 101 which cooperate over the web B; B′. Each of the printing couples 101 comprises printing couple cylinders 103; 104, one embodied as transfer cylinder 103 and one embodied as forme cylinder 104 (in short, cylinder 103; 104), along with an inking unit 105 and a dampening unit 106. In the embodiment shown in FIG. 1, each forme cylinder 104 of the printing unit 100 is equipped with a device 107 for semiautomatic or fully automatic plate loading or for changing printing formes 110, embodied as flexible printing plates 110.

The device 107 is embodied as having two parts. It has a nip device 197 (“semiautomatic forme changing apparatus” 197) situated in the area of a nip point between forme and transfer cylinder 104; 103. The device 107 further comprises a loader 198 with apparatuses for infeeding and receiving printing formes 110, which is structurally separate from the nip device.

In particular, if the printing press is to be configured for imprinting operation, it is equipped with additional guide elements 108 located a short distance upstream and downstream of the nip point of the printing unit 100. When the printing unit 100 will be traversed without imprinting and without contact between web B; B′ and transfer cylinders 103, the web path indicated by a dashed line in FIG. 1, which utilizes guide elements 108, is selected. Said web path is characterized in that the web B; B′ passes through the nip point in such a way that it essentially forms an angle of 80° to 100°, for example, about 90°, with the line of connection between the rotational axes of the two transfer cylinders 103. The guide elements 108 are preferably embodied as rods or rollers about which air can flow, which serve to diminish the risk of smearing freshly printed inks.

The number 109 identifies a washing device, one of which is assigned to each of the transfer cylinders 103. The washing device 109 is used to clean the elastic surface of the transfer cylinder 103.

Each of the cylinders 103; 104 has a circumference of between 540 and 700 mm, preferably between 540 and 630 mm, wherein forme cylinder 104 and transfer cylinder 103 preferably have the same circumference. Cylinders 103; 104 having different circumferences, for example, having a circumference of 546 mm, 578 mm, 590 mm, or 620 mm, may optionally be used. This is made possible, for example, by exchanging bearing elements or by adjusting the position of the bored holes in the side frame for the cylinders 103; 104 and by adjusting the drive.

Each of the transfer cylinders 103 has at least one packing, not shown in FIG. 1, on its outer surface. Said packing is preferably embodied as a metal printing blanket, which has an elastic layer (e.g., rubber) on an essentially dimensionally stable support layer. The support layer can be embodied in the form of a thin metal plate, for example. The packing preferably extends over the effective length or essentially over the entire intended printing width of the web B; B′, and essentially (up to a butt joint or a channel opening) about the entire circumference of the transfer cylinder 103.

For fastening the packing on the transfer cylinder 103, said cylinder has a groove extending axially on its outer surface, which extends over the entire usable width of the transfer cylinder 103. The width of the groove opening in the area of the outer surface is preferably 1 to 5 mm, particularly less than or equal to 3 mm, in the circumferential direction of the cylinder 103. The ends of said packing are inserted into the groove through an opening in the outer surface, and are held in place there in a frictional and/or positive connection by means of a latch mechanism, clamp, or chucking device. In the case of a metal printing blanket, the ends are bent/angled (e.g., approximately 45° at the leading end and approximately 135° at the trailing end). Clamping is preferably pneumatically actuable, for example, in the form of one or more pneumatically actuable levers, which when closed are prestressed by means of spring force against the trailing end which extends into the groove. A hose that can be pressurized with pressure medium can preferably be used as the actuating means.

The number 105 identifies the inking unit. In addition to an ink delivery system, such as a blade bar or an ink fountain 111 with an adjustment device 112 for regulating ink flow, for example, the inking unit has a plurality of rollers 113 to 125. When rollers 113 to 125 are engaged against one another, the ink travels from ink fountain 111 via ink fountain roller 113, film roller 114, and a first inking roller 115 to a first distribution cylinder 116. From there, depending upon the operating mode of the inking unit 15, the ink travels over at least one inking roller 117 to 120 to at least one additional distribution cylinder 121; 124. From said distribution cylinder 121; 124, the ink travels over forme rollers 122; 123; 125 to the surface of the forme cylinder 104.

In one advantageous embodiment, the ink travels alternately or simultaneously (in series or in parallel) via different possible paths from the first distribution cylinder 116 over two additional distribution cylinders 121; 124 to the forme rollers 122; 123; 125, as is shown in FIG. 1.

As FIG. 1 further shows, in an advantageous embodiment of the inking and dampening units 105; 106, the second distribution cylinder 124 can cooperate simultaneously with a roller 128, for example, forme roller 128, of the dampening unit 106.

By means of the roller 126 of the inking unit 105, ink can be removed from the inking unit 105 in the inking path, particularly upstream of the first distribution cylinder 116. This is accomplished by engaging a suitable removal device 133 against said roller 126 itself or, as is shown in FIG. 1, against a roller 127 cooperating with said roller.

The dampening unit 106 has a roller 128 and an additional roller 129 which cooperates with said roller. Roller 129 can be embodied as distribution roller 129, particularly as oscillating chromium roller 129. Roller 129 receives the dampening agent from a dampening device, which can be embodied, for example, in the form of a roller 130. The roller 130 can be embodied as a dipping roller 130, which dips into a dampening agent reservoir 132, for example, a water fountain. A drop sheet 135 for catching condensation water that forms on the water fountain is preferably arranged beneath the water fountain. In one advantageous embodiment, the drop sheet 135 can be heated, for example, using heating coils.

The distribution roller 129 and the dipping roller 130 are each driven by a separate rotational drive (not shown), particularly a drive motor, for example. Said drive motor can rotationally drive the respective rollers 129; 130 separately, mechanically independently of one another, via an angle transmission or bevel gear transmission. The drive motor is preferably embodied as a speed-controlled (particularly continuously) electric motor, particularly as a three-phase alternating current motor. The speeds and/or the dampening can advantageously be adjusted at the control panel, for example, at the ink control panel, where they are also displayed. In one preferred embodiment, the machine is controlled on the basis of a correlation between machine speed and dampening or rotational speed, which can be used to preset the speed of the two rollers 129; 130, particularly of roller 130, that is to be regulated.

As is further shown in FIG. 1, in one advantageous embodiment the rollers 117; 118; 128 are capable of moving between the positions indicated by solid and dashed lines. This refers to the operational movability of the rollers 117; 118; 128 between different operating positions and not to movability for purposes of adjustment. To shift the rollers 117; 118; 128 from one operating position to the other, positioning means and/or stops (e.g., adjustable), which can be actuated manually or via drives, can be provided—for both of the operational settings. In addition, either a greater adjustment path is allowed, or the roller arrangement is selected such that the two positions can be achieved via the customary adjustment path.

To allow the position of the forme roller 128 to be changed, in one advantageous embodiment, chromium roller 129 and roller 130 are mounted so as to be movable in a direction perpendicular to their respective axes, for example mounted in levers.

Distribution cylinders 116; 121; 124 of the inking unit 105 and roller 129 of the dampening unit 106 are mounted in side frames or frame walls (not shown) so as to be axially movable, and therefore they are able to execute an oscillating motion. The oscillating movement of the distribution cylinders 116; 121; 124 and the roller 129 is forced, for example, by means of an oscillating transmission that is coupled to the respective rotational drive.

A bearing which permits oscillation is also provided for roller 128 and for forme roller 123. However, the axial oscillating movement of rollers 128; 123 is effected not via an oscillating transmission but solely via friction with the cooperating cylindrical surfaces. Optionally, a bearing of this type, which has a degree of freedom in the axial direction, can also be provided for the two forme rollers 122 and 125.

The arrangement in the inking and dampening units 105; 106 indicated by solid lines in FIG. 1 shows the interaction of rollers 113 to 130 provided for “normal” print operation. Inking and dampening agent paths are connected to one another both via the second distribution cylinder 124 and via the forme cylinder 104. Dampening is implemented both directly and indirectly. The adjustability of roller 128 makes it possible to choose between direct dampening in the “three-roller dampening unit” and—depending upon the position of roller 117—indirect dampening or direct dampening in the “five-roller dampening unit.”

The printing couple cylinders 103; 104 and the rollers 113 to 130 of inking and dampening units 105; 106 are each mounted at their end surfaces in or on frame walls, not shown in detail here.

Roller 129 has, on its end surface which is opposite the rotational drive, an oscillating drive, not shown in FIG. 1, particularly a transmission for generating axial oscillating movement from the rotational movement. In order to avoid the generation of frictional heat in localized spots along the roller 129, said transmission is preferably situated outside of the roller body. In one advantageous embodiment, this transmission is located on the drive side of the printing unit 100, i.e., in the area of the same frame wall that holds the main drive, which is not shown in FIG. 1, and/or a drive train for printing couple cylinders 103; 104. Preferably, the rotational drive for rollers 129 and 130 is located on the opposite side, i.e., in the area of the other frame wall, also not shown in FIG. 1.

The printing unit 100 is also equipped with a device 199 for influencing the fan-out effect, i.e., a device 199 for influencing a change in the transverse extension/width of the web B; B′ from print position to print position, caused, for example, by the printing process (particularly the dampness), with said device being located in the intake area of the printing unit, or in the area of its infeed gap between the two transfer cylinders 103. The device 199 can have an adjustment element embodied as a nozzle, through which air can flow.

Driving is preferably implemented by means of a drive wheel, not shown in FIG. 1, which is driven by a main drive, for example, by a stationary electric motor, particularly by a torque angle controlled electric motor. The electric motor can be embodied as water cooled. A drive wheel of one of the two forme cylinders 104 is driven via an intermediate wheel. Said drive wheel drives the drive wheel of the transfer cylinder 103 to which said forme cylinder is assigned. The latter drive wheel then drives the drive wheel of the other transfer cylinder 103, which ultimately drives the drive wheel of the second forme cylinder 104. The drive wheels of the transfer cylinders 103 and forme cylinders 104 are non-rotatably connected to their respective cylinders 103; 104, for example, via pins. Via additional drive wheels and intermediate wheels, which are non-rotatably connected to the two forme cylinders 104 or to their drive wheels, one or more rollers 113 to 127 of the assigned inking unit 105 are rotationally driven.

Drive wheels of distribution cylinders 116; 121; 124 are driven via at least one intermediate wheel. The intermediate wheel meshes with the drive wheel of one of the forme cylinders 104. Thus, in the illustrated embodiment, the respective distribution cylinders 116; 121; 124 are rotationally driven by forme cylinder 104 via a positive drive connection. The drive connections can be embodied so as to enable axial movement of the distribution cylinders 116; 121; 124.

The ink fountain roller 113 has its own rotational drive, for example, its own mechanically independent drive motor, not shown here.

The remaining rollers 114; 115; 117 to 120; 122; 123 and 125 to 127 of the inking unit 105 are rotationally (and optionally axially) driven solely via friction. The inking unit 105 or distribution cylinders 116; 121; 124 are driven via the drive for the printing couple cylinders 103; 104.

FIG. 2 shows a printing tower with a plurality of printing units 100, for example, four, each consisting of two printing couples 101. The printing couples 101 each have two cooperating printing couple cylinders 103; 104, along with one inking unit 105 and one dampening unit 106 each, wherein in FIG. 2, for purposes of clarity, only rollers 128; 129; 130 of the dampening unit 106 are identified by symbols. Specifically, reference symbol 128 identifies the forme roller, reference symbol 129 identifies the distribution roller or the chromium roller, and reference symbol 130 identifies the dipping roller, which picks up dampening agent from a dampening agent reservoir 132 and transfers it to the chromium roller 129.

As is shown in FIG. 2, the printing tower has two side frames, in which a plurality of printing couples 101, for example, eight according to FIG. 2, each comprising printing couple cylinders 103; 104, inking unit 105 and dampening unit 106, are arranged vertically, one above the other, wherein in each case two printing couples 101 form one blanket-to-blanket printing unit 100, with this arrangement enabling the embodiment for four-color printing, for example. The print substrate B; B′, preferably a material web B; B′ (not shown), is passed through the printing tower between the printing couple cylinders 103 engaged against one another, preferably from bottom to top, and can be imprinted on both sides simultaneously. The printing tower shown in FIG. 2 can be a component of a newspaper printing press, for example.

FIG. 3 shows a perspective, exploded view of a magnetic coupling. The magnetic coupling comprises an outer rotor 300 and an inner rotor 301, wherein the outer rotor 300 is loaded on its interior side, and the inner rotor 301 is loaded on its exterior side, with high-powered magnets 305; 306, particularly permanent magnets 305; 306 of alternating polarity. In the idle status, the respective north and south poles of outer rotor 300 and inner rotor 301 are situated opposite one another. Twisting deflects the magnetic field lines, allowing torque to be transmitted via the air gap. Synchronous operation is established under constant torsional play. The magnets of the outer rotor 300 are identified by reference symbol 305, the magnets 306 of the inner rotor 301 are not shown in FIG. 3.

FIG. 4 shows a sectional illustration of a device in a printing couple 101 of a printing press, with a chromium roller 129 of the printing couple 101 having a magnetic coupling for transmitting torque from the drive means 302, for example, the separate drive 302, and for receiving the oscillating stroke. The chromium roller 129 is hard chromium plated. A separate rotational drive for the chromium roller 129 or the distribution roller 129 of a printing couple 101 as shown in FIG. 1 or FIG. 2 is identified by reference symbol 302.

The separate drive 302 is attached to the printing press, stationary, via a bolted connection. The separate drive 302 drives the drive shaft 303, for example, motor shaft 303, which is in turn non-rotatably connected to the outer rotor 300 of the magnetic coupling. The clamp ring 304 is used to mount the outer rotor 300 on the motor shaft 303. Said clamp ring is inserted into the wheel seat of the outer rotor 300 and then pushed onto the motor shaft 303. The clamp ring 304 is then aligned with the hub of the outer rotor 300, and finally, the tightening screws of the clamp ring 304 are tightened.

On its interior surface, the outer rotor 300 is equipped with permanent magnets 305, with north and south poles alternating in a circumferential direction.

The inner rotor 301, which is also equipped on its exterior surface with permanent magnets 306, with north and south poles alternating, runs inside the outer rotor 300. The inner rotor 301 is connected via clamp ring 307 to the end of the chromium roller 129 of the printing couple 101. The clamp ring 307 is mounted in the same manner as was described in reference to clamp ring 304 for connecting motor shaft 303 and outer rotor 300.

Roller 129 is placed in axially oscillating motion by an oscillating drive. The magnetic coupling is able to accept the oscillating stroke generated in this manner because the relative position of outer rotor 300 and inner rotor 301 is variable rather than fixed. When the roller 129 is in a first oscillating stroke position, outer rotor 300 and inner rotor 301 are arranged in a first position, and when the roller 129 is in a second oscillating stroke position, outer rotor 300 and inner rotor 301 are arranged in a second position, which is different from the first position. The oscillating stroke of the chromium roller 129 indicated by the double arrow in FIG. 4 can thus be accepted by the magnetic coupling without contact, and therefore also free from wear and tear.

Because it is free from any wear and tear, the magnetic coupling is also maintenance free.

FIG. 5 shows the separate drive 302 of the chromium roller 129 from a perspective view. Also shown is the outer rotor 300 of the magnetic coupling, which is non-rotatably connected to the motor shaft 303, not shown in FIG. 5.

The frictional stroke of the chromium roller 129 is introduced, for example, by means of the crank mechanism shown in FIG. 6. The drive unit 400, which can be embodied as an electric motor 400, for example, rotates the eccentric 401 via a transmission mechanism (not shown). The eccentric 401 drives the connector 402, for example a connecting rod 402, which converts the rotational movement of the eccentric 401 to a linear movement of the roller 129, i.e., to the oscillating stroke of the roller 129.

In principle, other oscillating drives which convert rotational movement of the roller to axially oscillating movement are also possible, such as oscillating transmissions, for example.

FIG. 7 shows a perspective view of a device, including chromium roller 129 and drive means 302 for effecting the rotational movement of the chromium roller 129. The drive means 302 consists of an electric motor 302, which can be embodied as a three-phase alternating current motor 302, which may be speed adjustable or speed controlled. As was specified in greater detail above, the electric motor 302 drives the outer rotor 300 of the magnetic coupling via its motor shaft 303. Torque is transmitted from the electric motor 302 to the chromium roller 129 via the inner rotor 301, not shown in FIG. 7, which is non-rotatably connected to the chromium roller 129.

The oscillating drive of the chromium roller 129 is not shown in FIG. 7. Said drive could be positioned, for example, on the opposite side of the chromium roller 129 from the separate rotational drive 302, and could be embodied, for example, as an oscillating transmission or as a crank mechanism according to FIG. 6.

The electric motor 302 can be arranged coaxially relative to the rotational axis of the roller 129.

The inner rotor 301 and the outer rotor 300 are capable of moving relative to one another in the direction of the rotational axis of the roller 129.

Either inner rotor 301 or outer rotor 300 is arranged immovably in the direction of the rotational axis of the roller 129.

The device in a printing couple 101 of a printing press with a magnetic bearing or a magnetic coupling is not limited to the chromium roller 129 of the dampening unit 106, but can alternatively or additionally be used with other rollers, for example, with rollers of the inking unit 105. Additionally, the device in a printing couple 101 of a printing press is not limited to the embodiments of a printing couple 101 shown in FIG. 1 or 2, but may also be used in printing couples 101 having different structures.

A stand-alone drive for the roller 129 is preferably a drive that is mechanically independent at least from the other rollers, i.e., it has no positive drive connection (e.g., toothed gears) to the rotational drive between roller 129 and the other rollers.

### LIST OF REFERENCE SYMBOLS

1-99 -
100 printing unit, blanket-to-blanket printing couple, I-type printing couple
101 printing couple, offset printing couple
102 roller
103 printing couple cylinder, cylinder, transfer cylinder
104 printing couple cylinder, cylinder, forme cylinder
105 inking unit
106 dampening unit
107 devices for semiautomatic or fully automatic plate supply
108 guide element
109 washing device
110 printing forme, printing plate
111 ink fountain
112 adjustment device
113 roller, ink fountain roller
114 roller, film roller
115 roller, inking roller
116 roller, distribution cylinder
117 roller, inking roller
118 roller, inking roller
119 roller, inking roller
120 roller, inking roller
121 roller, distribution cylinder
122 roller, forme roller
123 roller, forme roller
124 roller, distribution cylinder
125 roller, forme roller
126 roller
127 roller
128 roller, forme roller
129 roller, distribution roller, chromium roller
130 roller, dipping roller
131 -
132 dampening agent reservoir
133 removal device
134 -
135 drop sheet
136-196 -
197 nip device, semiautomatic forme changing apparatus
198 loader
199 device for influencing fan-out effect
200-299 -
300 outer rotor
301 inner rotor
302 drive means, separate drive, electric motor, three-phase alternating current motor
303 drive shaft, motor shaft
304 clamp ring
305 magnet, permanent magnet
306 magnet, permanent magnet
307 clamp ring
308-399 -
400 drive unit, electric motor
401 eccentric
402 connector, connecting rod
B print substrate, material web, paper web, web
B′ print substrate, material web, paper web, web

1-22. (canceled)

23. A device in a printing couple (101) of a printing press, at least having at least one roller (129) of an inking unit (105) or dampening unit (106) of the printing couple (101), at least one oscillating drive for generating an axial oscillating stroke of the roller (129), and at least one drive means (302) for generating a rotational movement of the roller (129), wherein the at least one drive means (302) is embodied as an electric motor (302) or has an electric motor (302), wherein a magnetic coupling comprising inner rotor (301) and outer rotor (300) is arranged between roller (129) and drive means (302), characterized in that to compensate for the oscillating stroke of the roller (129) elicited by the oscillating drive, the inner rotor (301) and the outer rotor (300) are capable of moving relative to one another in the direction of the rotational axis of the roller (129).

24. The device of claim 23, characterized in that the at least one drive means (302) is embodied in the form of a separate drive (302) for rotationally driving the roller (129), wherein torque is transmitted from said drive means to the roller (129) via the magnetic coupling.

25. The device of claim 23, characterized in that the relative position of outer rotor (300) and inner rotor (301) is variable in the direction of the rotational axis of the roller (129).

26. The device of claim 23, characterized in that when the roller (129) is in a first oscillating stroke position, the outer rotor (300) and the inner rotor (301) are arranged in a first position, and when the roller (129) is in a second oscillating stroke position, the outer rotor (300) and the inner rotor (301) are arranged in a second position, which is different from the first position.

27. The device of claim 23, characterized in that the electric motor (302) is arranged coaxially in relation to the rotational axis of the roller (129).

28. The device of claim 23, characterized in that the roller (129) is embodied as a distribution roller (129) of the dampening unit (106) of the printing couple (101).

29. The device of claim 23, characterized in that the roller (129) is embodied as a chromium roller (129), which cooperates with other rollers (128; 130) of the dampening unit (106) which have a rubber-coated surface.

30. The device of claim 29, characterized in that the other rollers (128; 130) of the dampening unit (106) consist of a forme roller (128) for applying the of moisture to the forme cylinder (104) of the printing couple (101) and a dipping roller (130) for taking up dampening agent from a dampening agent reservoir (132).

31. The device of claim 23, characterized in that the roller (129) is the only roller (129) of the dampening unit (106) that is equipped with its own separate drive (302).

32. The device of 23, characterized in that the drive means (302) has a drive shaft (303).

33. The device of claim 23, characterized in that the outer rotor (300) of the magnetic coupling is non-rotatably connected to the drive shaft (303).

34. The device of claim 23, characterized in that either inner rotor (301) or outer rotor (300) is positioned as stationary in the direction of the rotational axis of the roller (129).

35. The device of claim 23, characterized in that the inner rotor (301) is non-rotatably connected to the roller (129).

36. The device of claim 23, characterized in that the outer rotor (300) is non-rotatably connected to the drive shaft (303) of the drive means (302) by means of a clamp ring (304), and/or that the inner rotor (301) is non-rotatably connected to the roller (129) by means of a clamp ring (307).

37. The device of claim 23, characterized in that the at least one drive means (302) is positioned as stationary.

38. The device of claim 23, characterized in that the oscillating drive is embodied as a crank mechanism.

39. The device of claim 38, characterized in that the crank mechanism comprises a drive unit (400) and an eccentric (401), which cooperates with a connecting rod (402), which applies a force to the roller (129), which force acts in the axial direction of the roller (129).

40. The device of claim 23, characterized in that the oscillating drive comprises an oscillating transmission, which derives the oscillating stroke from the rotational movement of the roller (129).

41. The device of claim 23, characterized in that the dampening unit (106) comprises a forme roller (128), which can be pivoted away from the forme cylinder (104) for the purpose of washing.

42. The device of claim 23, characterized in that the oscillating drive is arranged on the end surface of the roller (129) that is opposite the drive means (302).

43. The device of claim 23, characterized in that the roller (129) and other rollers have no shared rotational drive, i.e., they are not in a positive drive connection.
